(19) United States
(12) Patent Application Publication
(10) Pub. No.: US 2002/0135770 A1
(43) Pub. Date: Sep. 26, 2002

(54) Hybrid-imaging spectrometer

(76) Inventors: E. Neil Lewis, Brookeville, MD (US); Kenneth S. Haber, Frederick, MD (US)

Correspondence Address: KRISTOFER E. ELBING, 187 PELHAM ISLAND ROAD, WAYLAND, MA, 01778, US

(21) Appl. No.: 09/828,281

(22) Filed: Apr. 6, 2001

Related U.S. Application Data
(63) Continuation-in-part of application No. 09/817,785, filed on Mar. 26, 2001.

(51) Int. Cl. G01J 3/51

(52) U.S. Cl. 356/419

(57) ABSTRACT

An imaging optical instrument for acquiring images of a sample area is disclosed. The instrument includes a spatial detector with aligned detector elements and a variable filter having filter characteristics that vary in at least one direction and are located in an optical path between the sample area and the spatial detector. An actuator is operatively connected between the variable filter and the spatial detector and is operative to move the variable filter along the direction in which the filter characteristics vary.

### CROSS-REFERENCE TO RELATED APPLICATION

This application is a continuation-in-part of a U.S. patent application entitled “Hybrid-Scanning Spectrometer” filed Mar. 26, 2001, Ser. No. ______, which is herein incorporated by reference.

### FIELD OF THE INVENTION

This invention pertains to spectrometers, and more particularly to imaging spectrometers that operate according to hybrid scanning methods.

### BACKGROUND OF THE INVENTION

Imaging spectrometers have been applied to a variety of disciplines, such as the detection of defects in industrial processes, satellite imaging, and laboratory research. These instruments detect radiation from a sample and process the resulting signal to obtain and present an image of the sample that includes spectral and chemical information about the sample. A few imaging spectrometers have been proposed that employ a variable-bandwidth filter. Such spectrometers generally include dispersive elements to limit the spectral information received by the array, or slits, apertures, or shutters to limit the spatial information received by the array.

### SUMMARY OF THE INVENTION

Several aspects of the invention are presented in this application. These are applicable to a number of different endeavors, such as laboratory investigations, microscopic imaging, infrared, near-infrared, visible absorption, Raman and fluorescence spectroscopy and imaging, satellite imaging, quality control, industrial process monitoring, combinatorial chemistry, genomics, biological imaging, pathology, drug discovery, and pharmaceutical formulation and testing.

Systems according to the invention are advantageous in that they can perform precise spectral imaging and computation with a robust and simple instrument. By acquiring a scanned series of mixed spectral images and then deriving pure spectral images from them, systems according to the invention can be made with few moving parts or more robust mechanisms than prior art systems. This is because they can be made using a simple variable optical filter in place of more costly interferometers, or active variable filters such as liquid crystal tunable filters (LCTF). The resulting systems can therefore be less expensive and more reliable.

Systems according to the invention can also acquire images with more efficiency because their detector arrays have a field of view that is not obstructed by slits or shutters and the average optical throughput of the filter is greater than other active tunable filter approaches. As a result, systems according to the invention need not suffer from the problems that tend to result from high levels of illumination, such as excessive heating of the sample, and the cost and fragility of high intensity illumination sources.

### BRIEF DESCRIPTION OF THE DRAWINGS

FIG. 1 is a diagram of an illustrative embodiment of an imaging spectrometer according to the invention, including a perspective portion illustrating the relationship between its image sensor, its variable filter, its actuator, and its sample area;

FIG. 2 is a plan view diagram of an image sensor for use with the process control system of FIG. 1;

FIG. 3 is a plan view diagram illustrating output of the system of FIG. 1;

FIG. 4 is a flowchart illustrating the operation of the embodiment of FIG. 1;

FIG. 5 is sectional diagram illustrating the sequential acquisition of a series of mixed spectral images of a sample with an embodiment of the invention in which the variable filter moves;

FIG. 6 is sectional diagram illustrating the sequential acquisition of a series of mixed spectral images of a sample with an embodiment of the invention in which the sample moves; and

FIG. 7 is a block diagram of another embodiment according to the invention, which is an example of a fluorescence measurement instrument that uses two variable filters.

In the figures, like reference numbers represent like elements.

### DESCRIPTION OF AN ILLUSTRATIVE EMBODIMENT

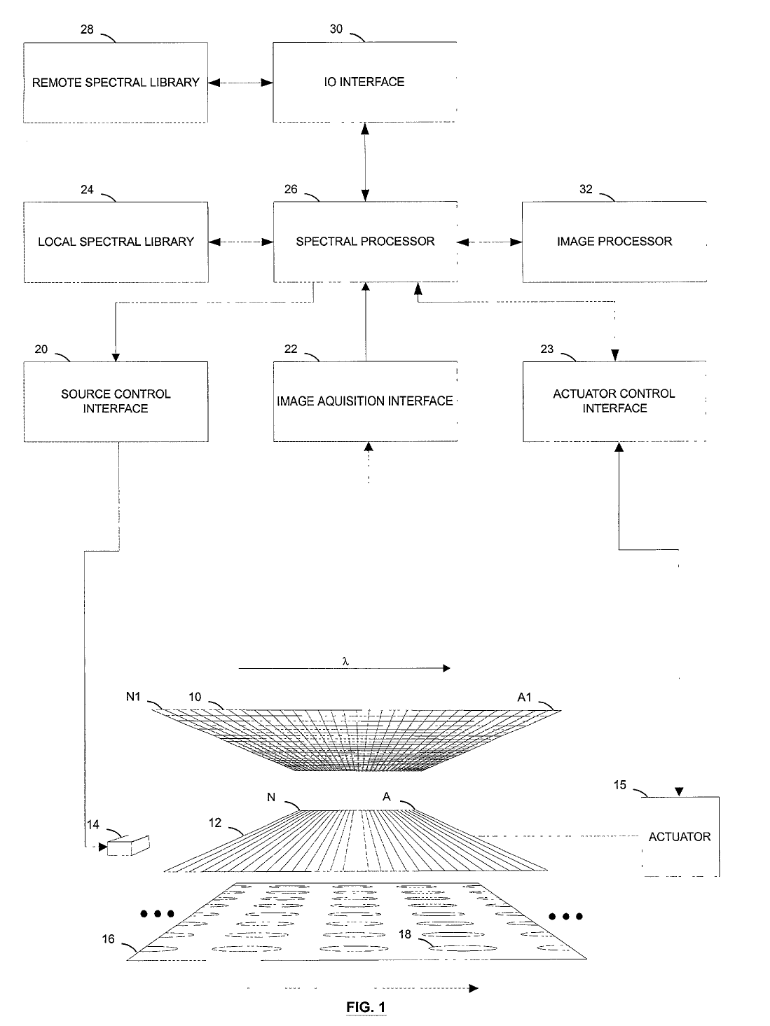

Referring to FIG. 1, an optical instrument according to the invention, features a two-dimensional array sensor 10 and a spatially-variable filter 12, such as a variable-bandpass filter, facing a sample area 16. The sample area can be a continuous area to be imaged, such as a tissue sample, or it can include a number of discrete sub-areas 18. These sub-areas can take on a variety of forms, depending on the type of instrument. In a macroscopic diagnostic instrument, for example, the sample areas can each be defined by one of a number of sample vessels. And in a microscopic instrument, the areas might be a number of reaction areas on a test chip. The instrument can also be used to examine a series of pharmaceutical dosage units, such as capsules, tablets, pellets, ampoules, or vials, or otherwise combined with the teachings described in applications entitled “High-Volume On-Line Spectroscopic Composition Testing of Manufactured Pharmaceutical Dosage Units,” including application Ser. No. 09/507,293, filed on Feb. 18, 2000, application Ser No. 60/120,859, filed on Feb. 19, 1999, and application Ser. No. 60/143,801, filed on Jul. 14, 1999, which are all herein incorporated by reference. The concepts presented in this application can also be combined with subject matter described in applications entitled “High-Throughput Infrared Spectrometry,” including application Ser. No. 09/353,325, filed Jul. 14, 1999, application Ser. No. 60/092,769 filed on Jul. 14, 1998, and application Ser. No. 60/095,800 filed on Aug. 7, 1998, all of which are herein incorporated by reference, as well as applications entitled “Multi-Source Array,” including application Ser. No. 60/183,663, filed on Feb. 18, 2000, and application Ser. No. 09/788,316, filed on Feb. 16, 2001, which are both herein incorporated by reference.

Where multiple sub-areas are used, the image sensor is preferably oriented with one or both of its dimensions generally along an axis that is parallel to the spatial distribution of sample elements. Note that the instrument need not rely on a predetermined shape for the elements, but instead relies on the fact that the actuator motion and acquisition are synchronized by the instrument.

The filter 12 has a narrow pass-band with a center wavelength that varies along one direction. The leading edge A of the filter passes shorter wavelengths, and as the distance from the leading edge along the process flow direction increases, the filter passes successively longer wavelengths. At the trailing edge N of the filter, the filter passes a narrow range of the longest wavelengths. The orientation of the filter can also be reversed, so that the pass-band center wavelength decreases along the process flow direction. Although the filter has been illustrated as a series of strips located perpendicular to the process flow direction, it can be manufactured in practice by continuously varying the dielectric thickness in an interference filter. Preferably, the filter should have a range of pass-bands that matches the range of the camera. Suitable filters are available, for example, from Optical Coatings Laboratory, Inc. of Santa Rosa, Calif. The variable filter can be located between the sample and the detector or between the source and sample. In a microscopic application, for example, the actuator can move the variable filter between the source and the sample, before light interacts with the sample. Alternatively, with the same optical configuration, the sample could be moved to achieve the same effect.

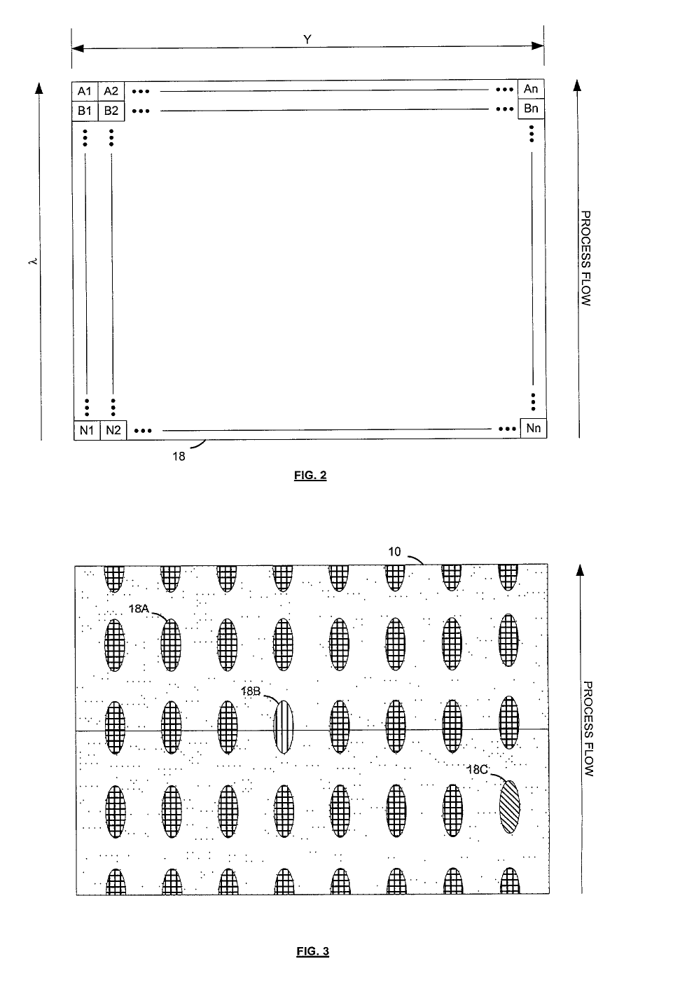

Referring to FIG. 2, the image sensor 10 is preferably a two-dimensional array sensor that includes a two-dimensional array of detector elements made up of a series of lines of elements (A1-An, B1-Bn . . . N1-Nn) that are each located generally along an axis that is perpendicular to the spatial distribution of sample elements. The image sensor can include an array of integrated semiconductor elements, and can be sensitive to infrared radiation. Other types of detectors can also be used, however, such as CCD detectors that are sensitive to ultraviolet light, or visible light. For near infrared applications, uncooled two-dimensionsal Indium-Gallium-Arsenide (InGaAs) arrays, which are sensitive to near-infrared wavelengths, are suitable image sensors, although sensitivity to longer wavelengths, such as Mercury-Cadmium-Telluride (MCT) would also be desirable. It is contemplated that the sensors should preferably have dimensions of at least 64×64 or even 256×256.

The system also includes an image acquisition interface 22 having an input port responsive to an output port of the image sensor 10. The image acquisition interface receives and/or formats image signals from the image sensor. It can include an off-the shelf frame grabber/buffer card with a 12-16 bit dynamic range, such as are available from Matrox Electronic Systems Ltd. of Montreal, Canada, and Dipix Technologies, of Ottawa, Canada.

A spectral processor 26 has an input responsive to the image acquisition interface 22. This spectral processor has a control output provided to a source control interface 20, which can power and control an illumination source 14, which can be placed to reflect light off the sample or transmit light through the sample. The illumination source for near-infrared measurements is preferably a Quartz-Tungsten-Halogen lamp. For Raman measurements, the source may be a coherent narrow band excitation source such as a laser. Other sources can of course also be used for measurements made in other wavelength ranges.

The spectral processor 26 is also operatively connected to a standard input/output (IO) interface 30 and may also be connected to a local spectral library 24. The local spectral library includes locally-stored spectral signatures for substances, such as known process components. These components can include commonly detected substances or substances expected to be detected, such as ingredients, process products, or results of process defects or contamination. The IO interface can also operatively connect the spectral processor to a remote spectral library 28.

The spectral processor 26 is operatively connected to an image processor 32 as well. The image processor can be an off-the-shelf programmable industrial image processor, that includes special-purpose image processing hardware and image evaluation routines that are operative to evaluate shapes and colors of manufactured objects in industrial environments. Such systems are available from, for example, Cognex, Inc.

An actuator 15 can be provided to move the filter 12 using a motive element, such as a motor, and a mechanism, such as a linkage, a lead screw, or a belt. The actuator is preferably positioned to move the filter linearly in the same direction along which its characteristics vary, or at least in such a way as to provide for at least a component of motion in this direction. In a related embodiment, the actuator moves the sample, such as by moving a sample platform. It may even be possible in some embodiments to move the camera or another element of the instrument, such as an intermediate mirror, if the arrangement allows for radiation from one sample point to pass through parts of the filter that have different characteristics before reaching the detector. In the present embodiment, the actuator includes a computer controlled motorized translation stage such as is available from National Aperture, of Salem, N.H.

The actuator can be a precise open-loop actuator, or can provide for feedback. Open loop actuators, such as precise stepper motors, allow the system to precisely advance the filter during acquisition. Feedback-based systems provide for a position or velocity sensor that indicates to the system the position of the filter. This signal can be used by the system to determine the position or velocity of the filter, and may allow the system to correct the filter scanning by providing additional signals to the actuator. The actuator can be designed to move the filter in a stepped or continuous manner.

In one embodiment, the system is based on the so-called IBM-PC architecture. The image acquisition interface 22, IO interface 30, and image processor 32 each occupy expansion slots on the system bus. The spectral processor is implemented using special-purpose spectral processing routines loaded on the host processor, and the local spectral library is stored in local mass storage, such as disk storage. Of course, other structures can be used to implement systems according to the invention, including various combinations of dedicated hardware and special-purpose software running on general-purpose hardware. In addition, the various elements and steps described can be reorganized, divided, and combined in different ways without departing from the scope and spirit of the invention. For example, many of the separate operations described above can be performed simultaneously according to well-known pipelining and parallel processing principles.

In operation, referring to FIGS. 1-4, the array sensor 10 is sensitive to the radiation that has interacted with the whole surface of the sample area 16, and focused or otherwise imaged by a first-stage optic, such as a lens (not shown). In operation of this embodiment, the acquisition interface 22 acquires data representing a series of variably-filtered, two-dimensional images. These two-dimensional images each include image values for the pixels in a series of adjacent lines in the sample area. Because of the action of the variable-bandpass filter, the detected line images that make up each two-dimensional image will have a spectral content that varies along one of the image axes.

One or more of the sample areas can include a reference sample. These sample areas can be located at fixed positions with respect to the other sample areas, or they can be located in such a way that they move with the scanning element of the instrument. This implementation can allow for the removal of transfer of calibration requirements between systems by simultaneously collecting reference spectra for spectral comparison. Referring to FIG. 4, spectral images can be assembled in a two-stage process. The first stage of the process is an acquisition stage, which begins with the acquisition of a first hybrid image of the sample S (step 40). The actuator is then energized to move the filter relative to the sample by a one pixel wide increment, and another mixed image is acquired. This part of the process can be repeated until the filter has been scanned across the whole image (step 42). At the end of this process stage, the system will have acquired a three-dimensional mixed spectral data set.

In the second stage image data are extracted from the mixed spectral data set and processed. In the embodiment described, pure spectral images are extracted in the form of a series of line images acquired at different relative positions (steps 46 and 48). Part or all of the data from the extracted line image data sets can then be assembled to obtain two-dimensional spectral images for all or part of the sample area and pure spectra for each pixel in the image

The conversion can take place in a variety of different ways. In one approach, a whole data set can be acquired before processing begins. This set can then be processed to obtain spectral images at selected wavelengths. The instrument may also allow a user to interact with an exploratory mode, in which he or she can look at representations of any subset of the data. This can allow the user to zoom in to specific parts of the sample and look at wavelengths or wavelength combinations that may not have been contemplated before the scan.

Data can also be processed as scanning of the filter occurs. In this approach, data may be processed or discarded as it is acquired, or simply not retrieved from the detector to create an abbreviated data set. For example, the instrument may only acquire data for a certain subset of wavelengths or areas, it may begin spectral manipulations for data as they are acquired, or it may perform image processing functions, such as spatial low-pass filtering, on data as they are acquired. Adaptive scanning modes may also be possible in which the instrument changes its behavior based on detected signals. For example, the instrument can abort its scan and alert an operator if certain wavelength characteristics are not detected in a reference sample.

In one example, the data can be accumulated into a series of single-wavelength bit planes for the whole image, with data from these bit planes being combined to derive spectral images. Data can also be acquired, processed, and displayed in one fully interleaved process, instead of in the two-stage approach discussed above. And data from the unprocessed data set can even be accessed directly on demand, such as in response to a user command to examine a particular part of the sample area, without reformatting the data as a whole.

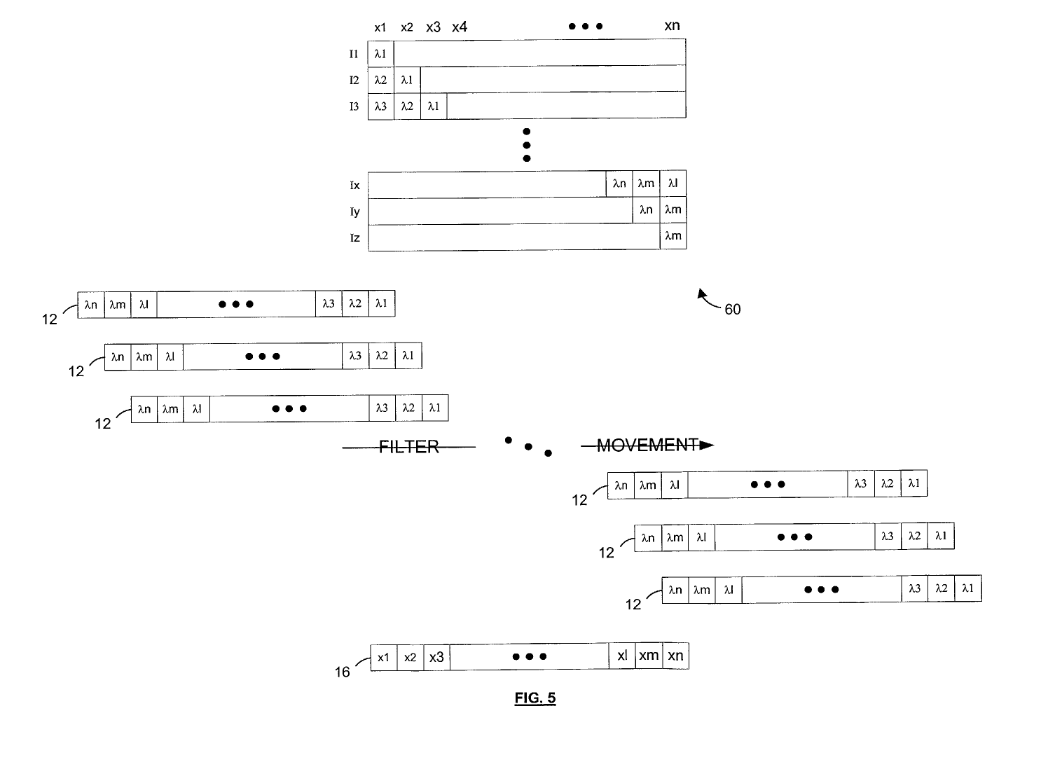

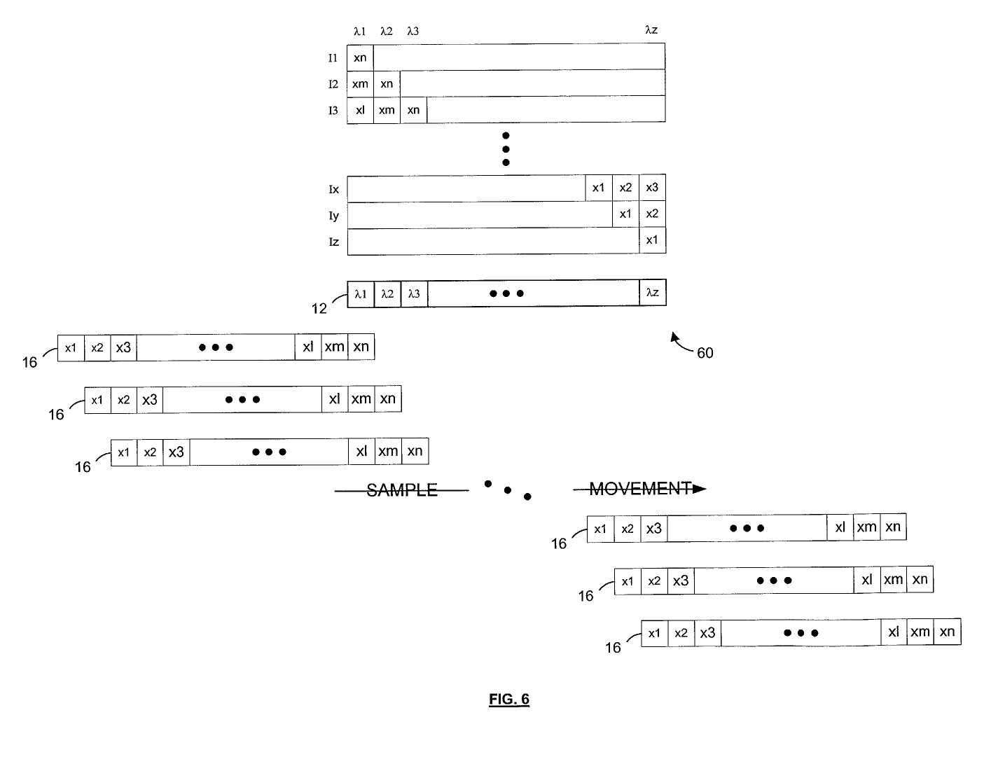

Referring to FIG. 5, the data set 60 will be acquired differently depending on which part or parts of the instrument are designed to move. In an instrument where a filter 12 moves in front of a stationary sample area 16, for example, the same line of detector array elements will acquire line images within different acquired image planes (I1, I2, . . . Iz) at different wavelengths (λ1, λ2, . . . λn) for the each part of the sample area (x1, x2, . . . xn) as the filter moves between the array and the sample area. The line images for a line on the sample will therefore be “stacked” in the data set. Substantially all of the data planes for the images will be only partially filed, however, and there will be twice as many images as needed. It may therefore be desirable to “square out” the data set into a right-angled array by shifting data, either as its is acquired and stored, or as a dedicated post-acquisition step.

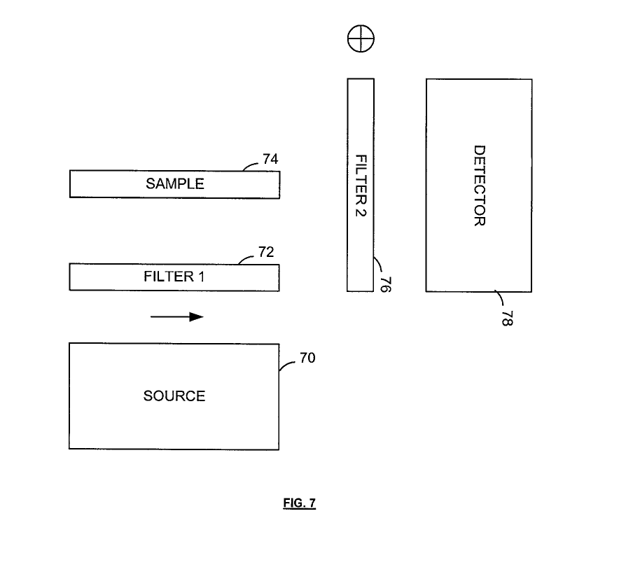

Referring to FIG. 6, in instruments where a sample area 16 moves in front of a stationary filter 12, the different lines of detector array elements will always acquire line images at a same respective wavelength (λ1, λ2, . . . λn). These acquisitions will be for different lines (x1, x2, . . . xn) of the sample area, however, as the sample moves. In this case, therefore, the line images for a single line on the sample will be offset along a diagonal (e.g., xn-xn- . . . -xn) through the data set 60. For this reason it may also be a good idea to “square out” the data set in these types of instruments.

The examples presented above assume that the filter is advanced by increments that each correspond to one row of pixels in the array. Other progressions are also possible, such as systems that move in sub-row (or multi-row) increments. And continuous systems may deviate significantly from their ideal paths, especially at the end of a scan. The specific nature of a particular instrument must therefore be taken into consideration in the designing of an acquisition protocol for a particular system.

Once the spectral images are assembled, the spectral processor 26 evaluates the acquired spectral image cube. This evaluation can include a variety of univariate and multivariate spectral manipulations. These can include comparing received spectral information with spectral signatures stored in the library, comparing received spectral information attributable to an unknown sample with information attributable to one or more reference samples, or evaluating simplified test functions, such as looking for the absence of a particular wavelength or combination of wavelengths. Multivariate spectral manipulations are discussed in more detail in “Multivariate Image Analysis,” by Paul Geladi and Hans, Grahn, available from John Wiley, ISBN No. 0-471-93001-6, which is herein incorporated by reference.

As a result of its evaluation, the spectral processor 26 may detect known components and/or unknown components, or perform other spectral operations. If an unknown component is detected, the system can record a spectral signature entry for the new component type in the local spectral library 24. The system can also attempt to identify the newly detected component in an extended or remote library 28, such as by accessing it through a telephone line or computer network. The system then flags the detection of the new component to the system operator, and reports any retrieved candidate identities.

Once component identification is complete, the system can map the different detected components into a color (such as grayscale) line image. This image can then be transferred to the image processor, which can evaluate shape and color of the sample or sample areas, issue rejection signals for rejected sample areas, and compile operation logs.

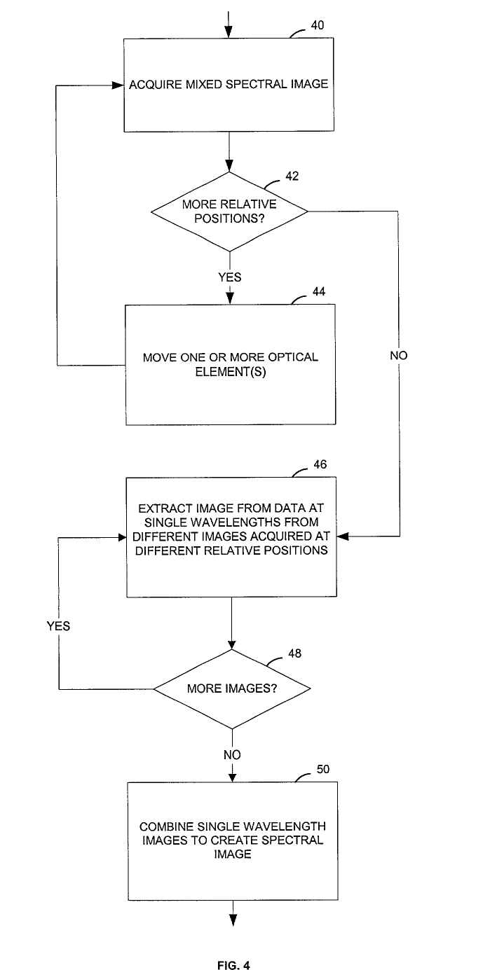

As shown in FIG. 3, the color image will resemble the sample area, although it may be stretched or squeezed in the direction of the actuator movement, depending on the acquisition and movement rates. The image can include a color or grayscale value that represents a background composition. It can also include colors or grayscale values that represent known good components or component areas 18A, colors that represent known defect components 18B, and colors or grayscale values that represent unknown components 18C. The mapping can also take the form of a spectral shift, in which some or all of the acquired spectral components are shifted in a similar manner, preserving the relationship between wavelengths. Note that because the image maps components to colors or grayscale values, it provides information about spatial distribution within the sample areas in addition to identifying its components.

While the system can operate in real time to detect other spectral features, its results can also be analyzed further off-line. For example, some or all of the spectral data sets, or running averages derived from these data sets can be stored and periodically compared with extensive off-line databases of spectral signatures to detect possible new contaminants. Relative spectral intensities arising from relative amounts of reagents or ingredients can also be computed to determine if the process is optimally adjusted.

Referring to FIG. 7, spectrometers according to the invention can also use more than one variable filter oriented in the same or a different direction. For example, in the embodiment shown in FIG. 7, a first filter 72 can filter radiation from a source 70 before it interacts with a sample 74. A second, different, filter 76 is rotated by 90 degrees about the optical axis with respect to the first filter. In this embodiment, the second filter and a detector 78 are also positioned such that the second filter will filter light received at a right angle from the sample before it is detected by the detector 78. The two filters are therefore part of the same the optical path from the detector, where that optical path can be bent at various angles or straight. This embodiment can be used in fluorescence measurements, with the first filter filtering the excitation wavelengths and the second filter filtering the emitted wavelengths, although other types of multi-filter embodiments can also be constructed. Embodiments of type shown in FIG. 7 can be used for two-dimensional fluorescence measurements (i.e. to make an excitation v. emission map) of a single uniform sample without moving any elements, or images may be obtained by scanning one or more of the elements of the apparatus in one or more directions.

In one embodiment, the spectrometer can be equipped with an additional magnifying optic that can be used to focus further in to specific points of interest within the instrument's field of view. This lens can even be such that it causes light from a single point on the sample to be incident across the entire filter and array, resulting in a single point “point-and-shoot” spectrometer in which the filter or sample do not need to be moved.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. An imaging optical instrument for acquiring images of a sample area, comprising:
a spatial detector including a plurality of aligned detector elements,
a variable filter having filter characteristics that vary in at least one direction, wherein there is an optical path from the variable filter to the spatial detector, and
an actuator operatively connected between the variable filter and the spatial detector and operative to move the variable filter relative to the spatial detector along the direction in which the filter characteristics vary.

2. The apparatus of claim 1 wherein the variable filter is a variable band-pass filter.

3. The apparatus of claim 1 wherein the variable filter is a continuously variable filter.

4. The apparatus of claim 1 further including an infrared source and wherein the spatial detector is an infrared detector.

5. The apparatus of claim 1 further including a near infrared source and wherein the spatial detector is a near infrared detector.

6. The apparatus of claim 1 further including an ultraviolet source and wherein the spatial detector is an ultraviolet detector.

7. The apparatus of claim 1 further including a visible light source and wherein the spatial detector is a visible light detector.

8. The apparatus of claim 1 further including a narrow-band source and wherein the spatial detector and the variable filter are operative on wavelengths outside of the bandwidth of the source.

9. The apparatus of claim 1 further including logic responsive to the spatial detector to combine a series of images from the spatial detector to obtain spectral images.

10. The apparatus of claim 1 further including logic responsive to the spatial detector to combine data from a series of image pixels from images acquired by the spatial detector to obtain individual pixel spectra.

11. The apparatus of claim 1 further including the step of shifting acquired data on a line-by-line basis as it is being acquired.

12. The apparatus of claim 1 further including a first stage optic between the sample and the detector.

13. The apparatus of claim 12 wherein the first stage optic is an image formation optic.

14. The apparatus of claim 12 wherein the first stage optic includes a magnifying optic.

15. The apparatus of claim 12 wherein the first stage optic includes portions of an endoscopic imaging probe.

16. The apparatus of claim 1 further including logic responsive to the detector to selectively display spectral information that relates to at least one predetermined substance in the sample.

17. The apparatus of claim 1 further including multivariate spectral analysis logic responsive to data acquired by the detector.

18. The apparatus of claim 1 wherein the spatial detector is a two-dimensional array detector.

19. The apparatus of claim 1 wherein the spatial detector is an integrated semiconductor array detector.

20. The apparatus of claim 1 wherein the variable filter is between the sample area and the spatial detector.

21. The apparatus of claim 1 further including a source and wherein the variable filter is between the source and the sample area.

22. An optical spectroscopic method, comprising:
filtering a plurality of radiation beam portions for different positions in a sample area with a filter having different filter characteristics and being located at a first position,
detecting the plurality of radiation beam portions with different parts of a spatial detector after filtering the radiation beam portions in the step of filtering,
moving the filter to a second position relative to a detector used in the step of detecting,
again filtering the plurality of radiation beam portions with the filter at the second position,
again detecting the plurality of radiation beam portions with different parts of a spatial detector after filtering the radiation beam portions in the step of again filtering, and
deriving spectral information from data acquired in the steps of detecting and again detecting.

23. The method of claim 22 wherein the step of deriving takes place after all of the steps of moving.

24. The method of claim 22 further including a step of focusing the radiation before the step of filtering.

25. The method of claim 22 wherein the steps of detecting acquire data representing a series of variably-filtered, two-dimensional images, and further including a step of combining the variably filtered images to obtain spectral images.

26. The method of claim 25 wherein the step of combining results in one or more Raman images.

27. The method of claim 25 wherein the step of combining results in one or more fluorescence images.

28. The method of claim 25 wherein the step of combining results in one or more infrared images.

29. The method of claim 25 wherein the step of combining results in one or more near-infrared images.

30. The method of claim 25 wherein the step of combining results in one or more visible images.

31. The method of claim 22 further including a step of providing a number of discrete sub-areas in the sample area.

32. The method of claim 31 wherein the step of providing sub-areas defines the sub-areas with an array of discrete reaction vessels.

33. The method of claim 31 wherein the step of providing sub-areas provides an array of different samples on a chip.

34. The method of claim 22 further including the step of magnifying the image before the step of detecting.

35. The method of claim 22 further including a step of performing a multivariate spectral analysis on results of the steps of detecting.

36. The method of claim 22 further including a step of selectively displaying spectral information that relates to at least one predetermined substance in the sample.

37. The method of claim 22 further including a step of providing a reference substance in the sample area.

38. The method of claim 22 wherein the steps of detecting are two-dimensional

39. A two-dimensional imaging optical instrument for acquiring images of a two-dimensional sample area irradiated by a source, comprising:
a two-dimensional spatial detector having detector elements aligned along a first axis and a second axis,
a two-dimensional variable filter having filter characteristics that vary in at least one dimension, wherein there is an optical path from the variable filter to the spatial detector, and
an actuator operatively connected to at least one of the source, the variable filter, the sample and the spatial detector, and operative to move at least the one of these elements with respect to at least another of these elements, wherein the actuator is driven by the instrument to enable detection of a predetermined sample area by a predetermined spatial detector area at a predetermined time.

40. The apparatus of claim 39 wherein the instrument includes common logic operative to control the actuator and cause the detector to acquire an image.

41. The apparatus of claim 39 wherein the spatial detector, the filter, and the actuator are all included in a same transportable instrument.

42. The apparatus of claim 41 wherein the instrument weighs less than 150 kilograms.

43. The apparatus of claim 39 wherein the source is an infrared source and wherein the spatial detector is an infrared detector.

44. The apparatus of claim 39 wherein the source is a near infrared source and wherein the spatial detector is a near infrared detector.

45. The apparatus of claim 39 further wherein the source is an ultraviolet source and wherein the spatial detector is an ultraviolet detector.

46. The apparatus of claim 39 further wherein the source is a visible light source and wherein the spatial detector is a visible light detector.

47. The apparatus of claim 39 wherein the source is a narrow-band source and wherein the spatial detector and the variable filter are operative on wavelengths outside of the bandwidth of the source.

48. The apparatus of claim 39 further including logic responsive to the spatial detector to combine a series of images from the spatial detector to obtain spectral images.

49. The apparatus of claim 39 further including logic responsive to the spatial detector to combine data from a series of image pixels from images acquired by the spatial detector to obtain individual pixel spectra.

50. The apparatus of claim 39 further including the step of shifting acquired data on a line-by-line basis as it is being acquired.

51. The apparatus of claim 39 further including a first stage optic between the sample and the detector.

52. The apparatus of claim 51 wherein the first stage optic is an image formation optic.

53. The apparatus of claim 51 wherein the first stage optic includes a magnifying optic.

54. The apparatus of claim 51 wherein the first stage optic includes portions of an endoscopic imaging probe.

55. The apparatus of claim 39 further including logic responsive to the detector to selectively display spectral information that relates to at least one predetermined substance in the sample.

56. The apparatus of claim 39 further including multivariate spectral analysis logic responsive to data acquired by the detector.

57. The apparatus of claim 39 wherein the spatial detector is an integrated semiconductor array detector.

58. An optical spectroscopic method, comprising:
filtering a plurality of radiation beam portions for a first set of different positions in a sample area with different filter characteristics,
detecting the plurality of radiation beam portions with different parts of a spatial detector after filtering the radiation beam portions in the first step,
successively filtering further pluralities of radiation beam portions for further sets of different positions in the sample area with the same filter characteristics after the steps of filtering and detecting, wherein the further sets of positions are different from the first set and from each other, and
successively detecting the further pluralities of radiation beam portions with different parts of a spatial detector after filtering the further pluralities of radiation beam portions, and
deriving spectral information about predetermined positions in the sample from data acquired in the steps of detecting and successively detecting.

59. The method of claim 58 further including a step of moving a filter that performs the first and third steps between the first and third steps.

60. The method of claim 59 wherein the step of moving the filter moves the filter relative to the rest of the elements in an instrument that performs the method.

61. The method of claim 59 wherein the step of moving the filter moves at least another element of an instrument that performs the method with respect to the filter, and wherein the filter remains stationary relative to the rest of the elements in the instrument.

62. The method of claim 59 wherein the step of moving and the steps of acquiring are responsive to common control logic.

63. The method of claim 58 further including a step of focusing the radiation before the step of filtering.

64. The method of claim 58 wherein the steps of detecting acquire data representing a series of variably-filtered, two-dimensional images, and further including a step of combining the variably filtered images to obtain spectral images.

65. The method of claim 64 wherein the step of combining results in one or more Raman images.

66. The method of claim 65 wherein the step of combining results in one or more fluorescence images.

67. The method of claim 65 wherein the step of combining results in one or more infrared images.

68. The method of claim 65 wherein the step of combining results in one or more near-infrared images.

69. The method of claim 65 wherein the step of combining results in one or more visible images.

70. The method of claim 58 further including a step of providing a number of discrete sub-areas in the sample area.

71. The method of claim 70 wherein the step of providing sub-areas defines the sub-areas with an array of discrete reaction vessels.

72. The method of claim 70 wherein the step of providing sub-areas provides an array of different samples on a chip.

73. The method of claim 58 further including the step of magnifying the image before the step of detecting.

74. The method of claim 58 further including a step of performing a multivariate spectral analysis on results of the steps of detecting.

75. The method of claim 58 further including a step of selectively displaying spectral information that relates to at least one predetermined substance in the sample.

76. The method of claim 58 further including a step of providing a reference substance in the sample area.

77. An optical instrument, comprising:
a spatial detector including a plurality of aligned detector elements,
a first variable filter having filter characteristics that vary in at least a first direction,
a second variable filter having filter characteristics that vary in at least a second direction, and
a sample area positioned such that there is an optical path that passes through the first filter, that interacts with the sample, that passes through the second filter, and that reaches the detector.

78. The apparatus of claim 77 wherein the optical path begins at a source, then passes through the first filter, then passes through the sample, then passes through the second filter, and then reaches the detector.

79. The apparatus of claim 77 further including an actuator connected to at least one of the variable filers, the sample area, and the spatial detector.

80. The apparatus of claim 77 wherein the variable filters are variable band-pass filters.

81. The apparatus of claim 77 wherein the variable filters are continuously variable filters.

82. The apparatus of claim 77 further including an ultraviolet source and wherein the spatial detector is an ultraviolet detector.

83. The apparatus of claim 77 further including an ultraviolet source and wherein the spatial detector is a visible detector.

84. The apparatus of claim 77 wherein the spatial detector and the second variable filter are operative on wavelengths outside of the bandwidth of the source.

85. The apparatus of claim 77 wherein the optical axes of the first and second filters are at an angle with respect to each other.

86. The apparatus of claim 85 wherein the optical axes of the first and second filters are at a right angle with respect to each other.

87. The apparatus of claim 77 wherein the first and second directions are at an angle with respect to each other.

88. The apparatus of claim 87 wherein the first and second directions are at a right angle with respect to each other.

89. The apparatus of claim 77 further including logic responsive to the spatial detector to combine a series of images from the spatial detector to obtain spectral images.

90. The apparatus of claim 77 further including logic responsive to the spatial detector to combine data from a series of image pixels from images acquired by the spatial detector to obtain individual pixel spectra.

91. The apparatus of claim 77 further including the step of shifting acquired data on a line-by-line basis as it is being acquired.

92. The apparatus of claim 77 further including a first stage optic between the sample and the detector.

93. The apparatus of claim 92 wherein the first stage optic is an image formation optic.

94. The apparatus of claim 92 wherein the first stage optic includes a magnifying optic.

95. The apparatus of claim 77 further including logic responsive to the detector to selectively display spectral information that relates to at least one predetermined substance in the sample.

96. The apparatus of claim 77 further including multivariate spectral analysis logic responsive to data acquired by the detector.

97. The apparatus of claim 77 wherein the spatial detector is an integrated semiconductor array detector.

98. The apparatus of claim 77 wherein the first variable filter is between the source and the sample area and wherein the second variable filter is between the sample area and the source.

99. The apparatus of claim 77 wherein the sample area is positioned such that there is an optical path that passes through the first filter, that then interacts with the sample, that then passes through the second filter, and that then reaches the detector.

100. The apparatus of claim 77 further including logic operatively connected to the detector to convert signals from the detector into a fluorescence excitation-emission map.

101. The apparatus of claim 77 further including logic operatively connected to the detector to convert signals from the detector into a spectral map.

102. The apparatus of claim 77 further including logic operatively connected to the detector to convert signals from the detector into a spectral map in real time.

103. The apparatus of claim 77 wherein the spatial detector is a two-dimensional array detector.

104. An optical spectroscopic method, comprising:
a first step including filtering a plurality of radiation beam portions for a first set of different positions in a sample area with a first set of different filter characteristics,
a second step including filtering a plurality of radiation beam portions for the first set of different positions in the sample area with a second set of filter characteristics different from the first set of filter characteristics, and
a third step including detecting a plurality of radiation beam portions each resulting from the first and second steps, wherein the third step takes place after the first and second steps.

105. The apparatus of claim 104 wherein the first step of filtering and the second step of filtering operate with their optical axes at an angle with respect to each other.

106. The apparatus of claim 105 wherein the first step of filtering and the second step of filtering operate with their optical axes at a right angle with respect to each other.

107. The apparatus of claim 104 wherein the first step of filtering and the second step of filtering operate with a direction of change of filter characteristics of the first step of filtering and a direction of change of filter characteristics of the second step of filtering at an angle with respect to each other.

108. The apparatus of claim 107 wherein the first step of filtering and the second step of filtering operate with a direction of change of filter characteristics of the first step of filtering and the direction of change of filter characteristics of the second step at a right angle with respect to each other.

109. The method of claim 104 further including a step of focusing the radiation before the step of filtering.

110. The method of claim 104 wherein the step of detecting acquires data representing a variably-filtered, two-dimensional image, and further including a step of combining the variably filtered image with other variably filtered images to obtain spectral images.

111. The method of claim 110 wherein the step of combining results in one or more fluorescence images.

112. The method of claim 104 further including a step of providing a number of discrete sub-areas in the sample area.

113. The method of claim 104 wherein the step of providing sub-areas defines the sub-areas with an array of discrete reaction vessels.

114. The method of claim 113 wherein the step of providing sub-areas provides an array of different samples on a chip.

115. The method of claim 104 further including the step of magnifying the image before the step of detecting.

116. The method of claim 104 further including a step of performing a multivariate spectral analysis on results of the step of detecting.

117. The method of claim 104 further including a step of selectively displaying spectral information that relates to at least one predetermined substance in the sample.

118. The method of claim 104 further including a step of providing a reference substance in the sample area.

119. The method of claim 104 further including a step of converting results of the step of detecting into a fluorescence excitation-emission map.

120. The method of claim 104 further including a step of converting results of the step of detecting into a spectral map.

121. The method of claim 104 further including a step of converting results of the step of detecting into a spectral map in real time.

122. The method of claim 104 further including a step of moving an optical element that performs one of the first, second, and a step of repeating the third step in concert with the step of moving.

123. The method of claim 104 further including a step of moving a filter that performs one of the first and second steps, and a step of repeating the third step in concert with the step of moving.
